(19) United States
(12) Patent Application Publication
(10) Pub. No.: US 2007/0020034 A1
(43) Pub. Date: Jan. 25, 2007

(54) Paint applicator

(76) Inventor: Miguel Wang, Chang-Hua Hsien (TW)

Correspondence Address: SEYFARTH SHAW LLP, 131 S. DEARBORN ST., SUITE2400, CHICAGO, IL, 60603-5803, US

(21) Appl. No.: 11/264,252

(22) Filed: Nov. 1, 2005

(30) Foreign Application Priority Data
Jul. 19, 2005 (TW) 094124345

(51) Int. Cl. B43M 11/06; B43K 5/00

(52) U.S. Cl. 401/207; 401/204

(57) ABSTRACT

A paint applicator includes a handle, a holder, and a hollow absorbent member. The handle includes a paint inlet end portion, a paint outlet end portion, and a first paint passage fluidly communicating with the paint inlet end portion and the paint outlet end portion. The holder includes a rear inlet portion connected fluidly and removably to the paint outlet end portion of the handle, a front outlet end, and a second paint passage extending between the rear inlet portion and the front outlet end. The hollow absorbent member includes a rear open end portion extending around the holder, and a front closed end portion extending forwardly of the front outlet end of the holder. The front closed end portion of the hollow absorbent member is connected fluidly to the front outlet end of the holder.

### CROSS-REFERENCE TO RELATED APPLICATION

This application claims priority of Taiwanese Application No. 094124345, filed on Jul. 19, 2005.

### BACKGROUND OF THE INVENTION

1. Field of the Invention

The invention relates to a paint applicator, more particularly to a paint applicator which can supply paint continuously.

2. Description of the Related Art

A paint roller and a paint brush are two types of paint applicators. Conventionally, the paint roller requires repeated dipping of a roller portion of the paint roller into a tray of paint when conducting the painting activity. Similarly, the paint brush requires repeated dipping of bristles of the paint brush into a container of paint. Therefore, the conventional paint roller and paint brush are relatively inconvenient to use. Furthermore, cleaning of the conventional paint applicators, especially the paint brush, is often a time consuming and tedious activity. Normally, the bristles of the paint brush are cleaned by washing the bristles in a bucket of cleaning fluid or water. However, it is difficult to clean the bristles of the paint brush to the satisfaction of the user of the paint brush. Additionally, only the outer bristles have direct contact with the cleaning fluid or water in the bucket. Therefore, the cleaning fluid or water in the bucket cannot effectively penetrate or circulate throughout the bristles such that the bristles are not thoroughly cleaned.

Referring to FIGS. 1 and 2, a paint brush disclosed in Taiwanese Patent Publication No. 543395 includes a handle 10, a body member 20, bristles 30, and a plug member 40.

The handle 10 includes a paint inlet end portion 11, a paint outlet end portion 12 opposite to the paint inlet end portion 11, and a paint passage 13 fluidly communicating with the paint inlet end portion 11 and the paint outlet end portion 12.

The body member 20 is connected to the paint outlet end portion 12 of the handle 10, and includes an inlet portion 21 connected fluidly to the paint passage 13 of the handle 10, and an assembling portion 22 for assembling the bristles 30 and the plug member 40 therein.

The plug member 40 includes an annular bristle-assembling portion 41, and a plurality of paint outlet holes 42. During assembly, the bristles 30 are first assembled in the annular bristle-assembling portion 41 of the plug member 40, and the plug member 40 with the bristles 30 are then assembled in the assembling portion 22 of the body member 20.

When the paint brush is in use, paint can flow from the paint inlet end portion 11 of the handle 10 to the bristles 30 via the paint passage 13 of the handle 10, the paint outlet end portion 12, the inlet portion 21 of the body member 20, and the paint outlet holes 42 of the plug member 40 so that the bristles 30 can be supplied with the paint continuously.

However, the aforesaid paint brush has the following disadvantages:

1. After a period of use, the paint outlet holes 42 of the plug member 40 are likely to be blocked due to solidification of the paint. Therefore, the bristles 30 can not be provided with the paint efficiently.

2. In the aforesaid paint brush, the bristles 30 are coated entirely with the paint. However, it is only required to provide the distal portions of the bristles 30 with the paint when conducting the painting activity. Therefore, the aforesaid paint brush suffers from a problem of unnecessary consumption of the paint. Furthermore, it is relatively difficult to clean the paint brush to the satisfaction of the user.

3. The bristles 30 of the aforesaid paint brush can not be replaced with new ones after a period of use.

### SUMMARY OF THE INVENTION

Therefore, the object of the present invention is to provide a paint applicator which can supply paint continuously, and which can avoid ineffective consumption of the paint.

Accordingly, the paint applicator of this invention includes a handle, a holder, and a hollow absorbent member. The handle includes a paint inlet end portion, a paint outlet end portion opposite to the paint inlet end portion, and a first paint passage fluidly communicating with the paint inlet end portion and the paint outlet end portion. The holder includes a rear inlet portion connected fluidly and removably to the paint outlet end portion of the handle, a front outlet end opposite to the rear inlet portion, and a second paint passage extending between the rear inlet portion and the front outlet end. The hollow absorbent member is sleeved around the holder, and includes a rear open end portion extending around the holder, and a front closed end portion extending forwardly of the front outlet end of the holder. The front closed end portion of the hollow absorbent member is connected fluidly to the front outlet end of the holder.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional paint brush;

FIG. 2 is another sectional view of the conventional paint brush;

FIG. 3 is an exploded perspective view of a preferred embodiment of a paint applicator according to this invention;

FIG. 4 is a sectional view of the preferred embodiment;

FIG. 5 is a schematic view of the preferred embodiment; and

FIGS. 6 and 7 are sectional views showing consecutive steps of assembling the preferred embodiment.

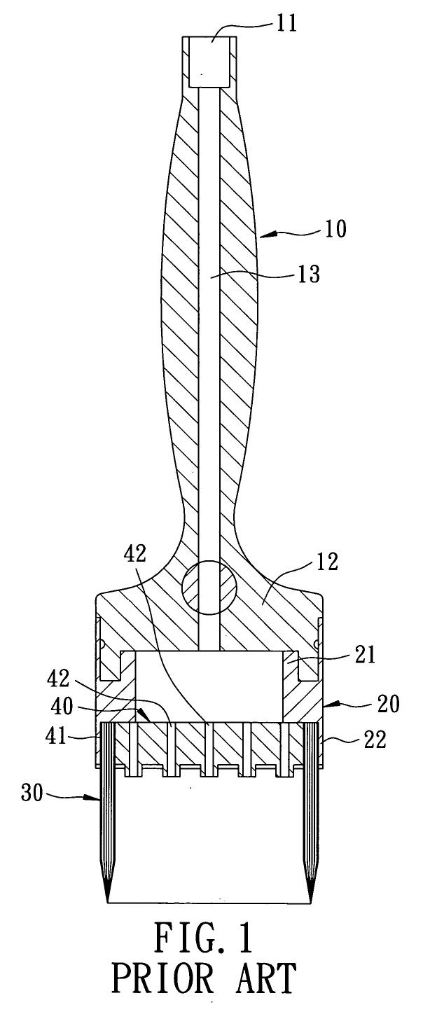

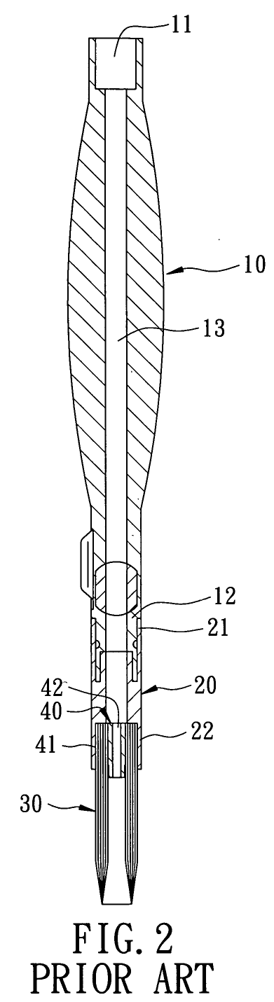

### DETAILED DESCRIPTION OF THE PREFERRED EMBODIMENT

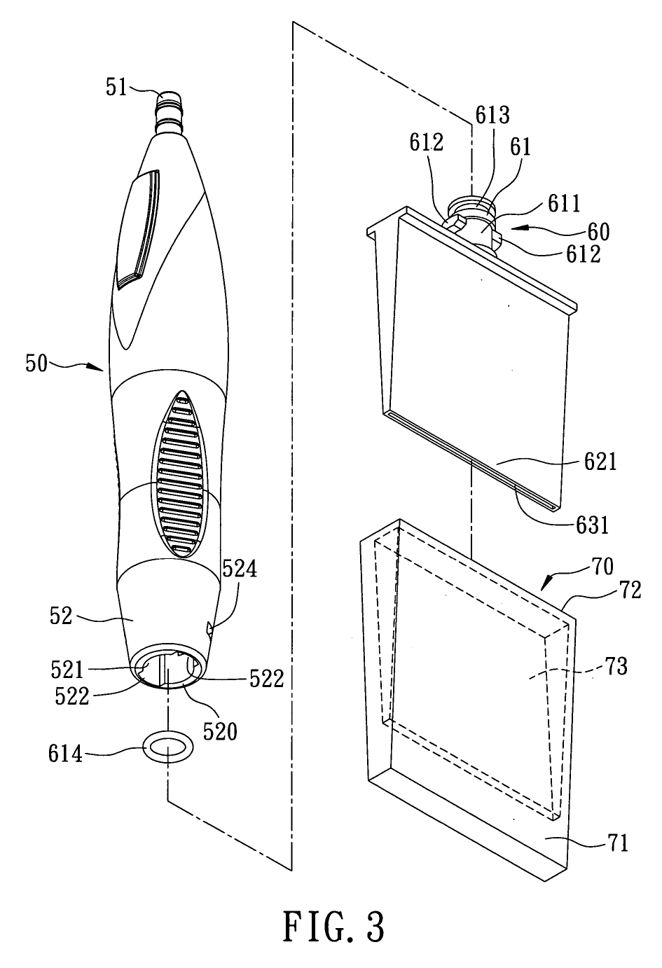

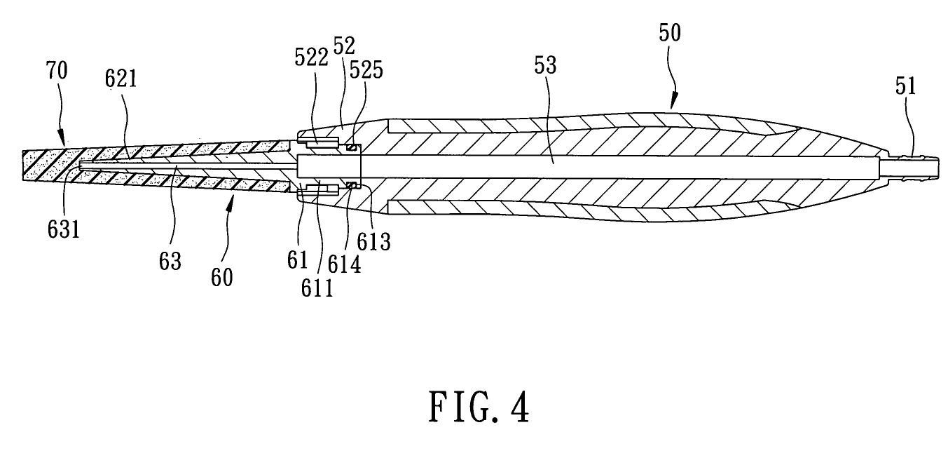

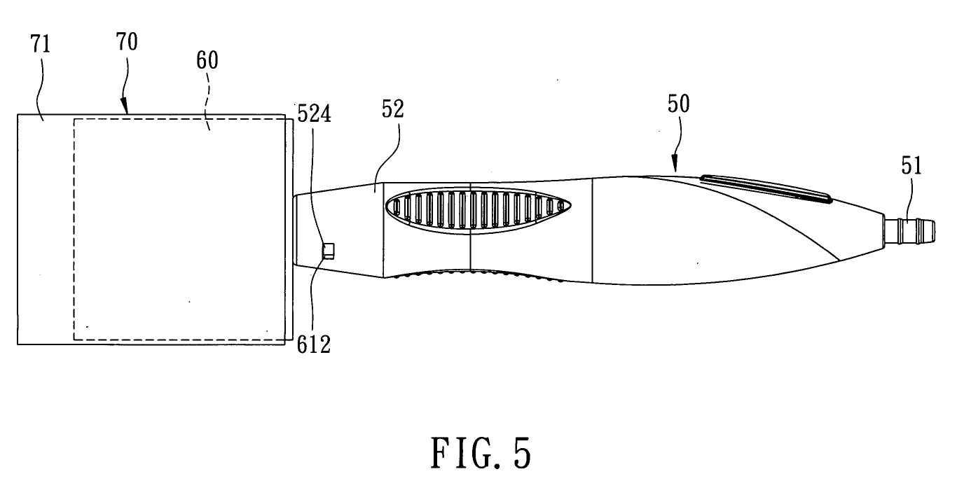

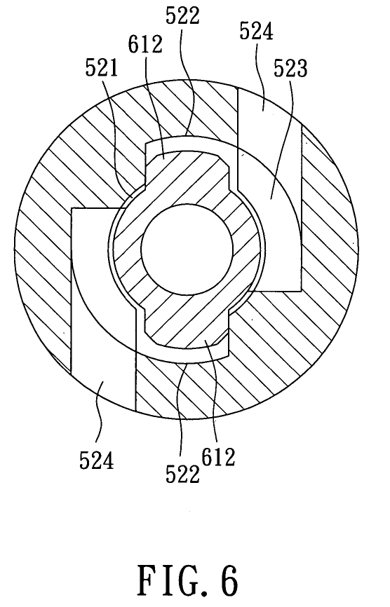

Referring to FIGS. 3, 4, 5, and 6, the preferred embodiment of a paint applicator according to this invention is shown to include a handle 50, a holder 60, and a hollow absorbent member 70.

The handle 50 includes a paint inlet end portion 51, a paint outlet end portion 52 opposite to the paint inlet end portion 51, and a first paint passage 53 fluidly communicating with the paint inlet end portion 51 and the paint outlet end portion 52. The paint outlet end portion 52 of the handle 50 includes a tubular wall 520 defining an axial fastening hole 521, two limiting recesses 522 formed in the tubular wall 520 and extending radially from the axial fastening hole 521 and axially toward the paint inlet end portion 51, two through holes 524 extending through the tubular wall 520 and staggered angularly with the limiting recesses 522, respectively, and limiting grooves 523, each of which extends angularly from a corresponding one of the limiting recess 522 to a corresponding one of the through holes 524. The tubular wall 520 of the paint outlet end portion 52 of the handle 50 further has an annular sealing groove 525, the radius of which is smaller than that of each of the limiting grooves 523.

The holder 60 has a substantially wedge shape, and includes a rear inlet portion 61 connected fluidly and removably to the paint outlet end portion 52 of the handle 50, a front outlet end 621 opposite to the rear inlet portion 61, and a second paint passage 63 extending between the rear inlet portion 61 and the front outlet end 621, and communicated fluidly with the first paint passage 53 of the handle 50. The front outlet end 621 of the holder 60 is formed with an elongate opening 631 fluidly communicated with second paint passage 63. The rear inlet portion 61 of the holder 60 includes an annular wall 611 inserted into the fastening hole 521 of the tubular wall 520 of the paint outlet end portion 52 of the handle 50, and two limiting blocks 612 protruding from the annular wall 611.

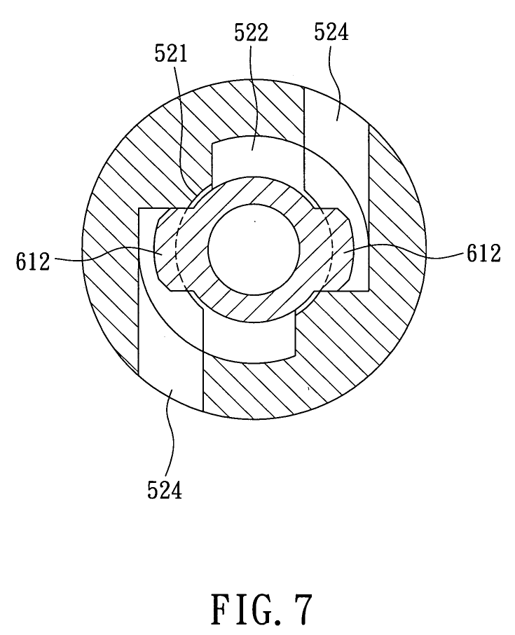

Referring to FIG. 7, the limiting blocks 612 are engaged in the through holes 524, respectively, after passing through the limiting recesses 522 and the limiting grooves 523 upon rotation of the holder 60 relative to the handle 50. The annular wall 611 of the rear inlet portion 61 of the holder 60 further includes an annular sealing recess 613 proximate to the limiting blocks 612, and a sealing ring 614 disposed in the annular sealing recess 613. The sealing ring 614 engages the annular sealing groove 525 in the tubular wall 520 of the paint outlet end portion 52 of the handle 50.

The hollow absorbent member 70 is sleeved around the holder 60, and includes a rear open end portion 72 extending around the holder 60, and a front closed end portion 71 extending forwardly of the front outlet end 621 of the holder 60. The front closed end portion 71 of the hollow absorbent member 70 is connected fluidly to the front outlet end 621 of the holder 60. The rear open end portion 72 of the hollow absorbent member 70 is proximate to the rear inlet portion 61 of the holder 60. The hollow absorbent member 70 is made of a foam material, and includes a substantially wedge-shaped receiving space 73 to receive the holder 60.

In use, paint flows continuously from the paint inlet end portion 51 of the handle 50 to the front outlet end 621 of the holder 60 via the first paint passage 53 and the paint outlet end portion 52 of the handle 50, and the rear inlet portion 61 and the second paint passage 63 of the holder 60. The front closed end portion 71 of the hollow absorbent member 70 absorbs the paint passing through the elongate opening 631 of the holder 60 so that paint application can be conducted. Therefore, it is not necessary to soak the whole hollow absorbent member 70 with the paint. The problem of ineffective consumption of the paint suffered in the prior art can be avoided accordingly.

Furthermore, the foam material of the hollow absorbent member 70 is used to conduct the paint application, and the elongate opening 631 is relatively large as compared to the paint outlet holes 42 of the plug member 40 of the aforesaid prior art. Therefore, cleaning of the paint applicator of the present invention can be conducted with relative ease.

It should be noted that since paint application can be conducted using the front closed end portion 71 of the hollow absorbent member 70, the remaining portion of the hollow absorbent member 70, i.e., except the front closed end portion 71, can be made of a material other than foam material.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A paint applicator, comprising:
a handle including a paint inlet end portion, a paint outlet end portion opposite to said paint inlet end portion, and a first paint passage fluidly communicating with said paint inlet end portion and said paint outlet end portion;
a holder including a rear inlet portion connected fluidly and removably to said paint outlet end portion of said handle, a front outlet end opposite to said rear inlet portion, and a second paint passage extending between said rear inlet portion and said front outlet end; and
a hollow absorbent member sleeved around said holder, and including a rear open end portion extending around said holder, and a front closed end portion extending forwardly of said front outlet end of said holder, said front closed end portion of said hollow absorbent member being connected fluidly to said front outlet end of said holder.

2. The paint applicator as claimed in claim 1, wherein said rear open end portion of said absorbent member is proximate to said rear inlet portion of said holder.

3. The paint applicator as claimed in claim 1, wherein said paint outlet end portion of said handle includes a tubular wall defining an axial fastening hole, a limiting recess formed in said tubular wall and extending radially from said axial fastening hole and axially toward said paint inlet end portion, a through hole extending through said tubular wall and staggered angularly with said limiting recess, and a limiting groove extending angularly from said limiting recess to said through hole, said rear inlet portion of said holder including an annular wall inserted into said fastening hole in said tubular wall, and a limiting block protruding from said annular wall, said limiting block being engaged in said through hole after passing through said limiting recess and said limiting groove upon rotation of said holder relative to said handle.

4. The paint applicator as claimed in claim 3, wherein said annular wall of said rear inlet portion of said holder further includes an annular sealing recess proximate to said limiting block, and a sealing ring disposed in said annular sealing recess, said tubular wall of said paint outlet end portion of said handle having an annular sealing groove to engage said sealing ring.

5. The paint applicator as claimed in claim 1, wherein said holder has a substantially wedge shape.

6. The paint applicator as claimed in claim 5, wherein said hollow absorbent member is made of a foam material, and includes a substantially wedge-shaped receiving space to receive said holder.
